(19) United States
(12) Patent Application Publication
(10) Pub. No.: US 2026/0007189 A1
(43) Pub. Date: Jan. 8, 2026

(54) FABRIC FOR MOISTURE CONTROL AND USES THEREFOR

(71) Applicant: The Hong Kong Polytechnic University, Hong Kong (CN)

(72) Inventors: Dahua SHOU, Hong Kong (CN); Yuheng GU, Hong Kong (CN)

(21) Appl. No.: 18/764,400

(22) Filed: Jul. 5, 2024

(51) Int. Cl. A41D 1/00; D04B 1/12; D04B 1/24; D04B 21/08; D04B 21/20; D06M 15/256; D06M 23/16; D06M 101/40

(52) U.S. Cl. CPC A41D 1/002; D04B 1/12; D04B 1/246; D04B 21/08; D04B 21/207; D06M 15/256; D06M 23/16; A41D 2500/10; D06M 2101/40; D06M 2200/12; D10B 2401/021; D10B 2401/022; D10B 2501/00

(57) ABSTRACT

This invention provides a fabric for moisture control of a surface. In one embodiment, the fabric comprises a moisture collection component (1) or/and a moisture dissipation component (2); wherein the moisture collection component (1), comprises an outer surface (11) exposed to ambient environment and an inner surface (12) for contacting the surface, wherein moisture is removed from the surface due to passive forces acting in a capillary network (13) present in said moisture collection component (1); said moisture dissipation component (2), comprises a first electrode layer (24), a second electrode layer (25), one or more porous insulation layer (201) and an electrical supply (23), wherein the one or more porous insulation layer (201) is positioned between the first electrode layer and the second electrode layer while the electrical supply (23) maintains a voltage difference to drive an electroosmotic liquid flow.

### FIELD OF THE INVENTION

The present invention relates to fabrics for moisture control, particularly, fabrics with active moisture management.

### BACKGROUND OF THE INVENTION

Effective personal moisture management is pivotal for ensuring comfort and enhancing performance, particularly in individuals with active lifestyles experiencing varied thermal conditions. There is a notable demand for innovative activewear that swiftly wicks away sweat, maintaining a dry state for the wearer. While swiftly wicking materials have become prevalent in activewear, facilitating quick absorption and migration of sweat, they fall short during intense sweating episodes. The garments tend to absorb moisture until they're saturated, becoming heavy, sticking to the skin, and losing their breathability, thereby hampering wearability due to the inefficient release of accumulated perspiration.

To counteract this, significant efforts have been directed toward improving liquid migration within activewear via better capillary action, utilizing hydrophilic fabrics and yarns. Natural fibers, such as cotton and wool, known for their moisture uptake, have been optimized to wick away moderate sweat. Yet these materials prove inadequate during profuse sweating as they retain moisture and become burdensome. Consequently, synthetic fibers—polyester, in particular—have emerged as solutions due to their low moisture affinity and rapid drying properties. Advanced production techniques yield synthetic fibers with microgrooves, enhancing liquid dispersion and capillarity. Although these innovative fibers exhibit increased wicking and quick-dry properties, they still tend to reach saturation under heavy sweating, and the garment's evaporative cooling often fails to keep pace with intense perspiration, revealing a gap that current technologies have yet to bridge.

To maintain dry skin, various approaches have been employed through modifying wicking fabric surfaces. Wicking Windows technology partially renders the inner surface of cotton fabrics non-absorbent to channel more moisture to the outer surface, enhancing evaporation. Currently, many scholars have also conducted numerous studies related to this topic, this includes that fabrics are engineered to exhibit differential wettability, causing moisture to migrate from hydrophobic to hydrophilic sides. A layered fabric system has been devised, consisting of an inner moisture-permeable hydrophobic layer, a middle hydrophilic layer for moisture transport, and an absorbent outer hydrophilic layer to capture sweat. One-sided fabric treatment with UV-responsive super-hydrophobic coatings induces asymmetric wettability and directional liquid flow. Hydrophobic sprays create a wettability gradient through the fabric thickness, while a Janus polyester/nitrocellulose fabric with a conical micropore arrangement boasts exceptional directional water transport, as recorded by moisture management testing. A Janus textile integrates thermoresponsive polymers, offering reversible wettability for adaptive moisture directionality and thermoregulation with temperature shifts.

This invention focuses on harnessing hydrophilic fibrous layers to achieve unidirectional moisture transfer. Theoretically, tree-like structures may amplify capillary action. Despite these developments, moisture can often get trapped within hydrophilic zones, leading to heavy and uncomfortable wear. The envisioned activewear is designed to expedite the expulsion of excessive sweat in the form of droplets using a textile-integrated, low-voltage electro-wicking mechanism. This technology has the capacity to match the elevated perspiration rate typical of an active adult and offers customizable settings to adapt to varying levels of sweat production. Additionally, an innovative liquid transport system emulating root structures is introduced to mitigate the sensation of moisture and adherence to the skin. This system will utilize a combination of hydrophilic and hydrophobic fibers, precisely arranged through programmable knitting techniques. The garment is specifically engineered to direct moisture transfer and distribution, routing perspiration efficiently to designated electro-wicking zones for rapid evaporation.

### SUMMARY OF THE INVENTION

This invention provides a fabric for moisture control of a surface. In one embodiment, said fabric comprises a moisture collection component (1) or/and a moisture dissipation component (2); wherein said moisture collection component (1), comprises an outer surface (11) exposed to ambient environment and an inner surface (12) for contacting said surface, wherein moisture is removed from said surface due to passive forces acting in a capillary network (13) present in said moisture collection component (1); said moisture dissipation component (2), comprises a first electrode layer (24), a second electrode layer (25), one or more porous insulation layer (201) and an electrical supply (23), wherein said one or more porous insulation layer (201) is positioned between said first electrode layer and said second electrode layer while said electrical supply (23) maintains a voltage difference to drive an electroosmotic liquid flow.

This invention further provides a garment made using the fabric of this invention.

This invention also provides a system for moisture control of a surface. In one embodiment, said system comprises: a) the fabric of this invention; b) a mobile device; and c) a wireless module to achieve a desired liquid transport rate for said fabric by: i) Receiving instructions from said mobile device; and ii) Controlling said electrical supply based on said instructions to adjust said voltage difference to arrive at said desired liquid transport rate.

### BRIEF DESCRIPTION OF THE FIGURES

FIG. 1A shows an embodiment of this invention whereby the fabric is used in an active perspiration garment, it includes a garment with root-like liquid collect pattern, the electroosmosis fabric is at the bottom connected with power supply.

FIG. 1B shows the APP design in one embodiment of this invention for controlling moisture.

FIG. 1C shows an embodiment of the electroosmosis fabric with water supply.

FIG. 1D shows the knitting fabric with hydrophobic and hydrophilic patterns in one embodiment of this invention.

FIG. 2 shows the fabrication method of an active perspiration garment in one embodiment of this invention.

FIG. 3 shows an image of one embodiment of this invention taken by an infrared thermal camera, it indicates the liquid dissipation route with a root-like structure in 360 seconds.

FIG. 4A and FIG. 4B show the experiment process of cling force test.

FIG. 4C shows the cling force of treated fabric and pristine fabric.

FIG. 4D shows the experimental set up for testing the cling force of fabrics.

FIG. 5 shows three prototypes of garment with root-like structure, the first two are made by knitting technology, the last one is made by chemical treatment to a knitted cotton garment.

FIG. 6A shows experimental set up for testing the rate of water transportation.

FIG. 6B shows the power consumption of the electroosmosis fabric under different voltage.

FIG. 6C shows the electrical current of electroosmosis fabric under different voltage, respectively.

FIG. 6D shows the transported liquid amount of electroosmosis garment under 5V.

FIG. 6E shows the sweat dissipation rate of active perspiration garment after 500 cycles wash.

FIG. 7 shows the electroosmosis fabric in one embodiment of this invention with liquid supply under different voltage.

FIG. 8A shows the sweat dissipation rate of active perspiration garment from 0 hour to 100 hours with saline.

FIG. 8B shows the contact angle change of active perspiration garment after 500 cycles.

FIG. 9A shows the SEM photos of pristine fabric (left), carbon fabric covered with PVA solution (middle), PTFE film (right).

FIG. 9B is the MMT (Moisture Management Tester) result of the electroosmosis fabric in one embodiment of this invention.

FIG. 9C is the tensile strength of the electroosmosis fabric in one embodiment of this invention.

FIG. 9D shows the hydrophilic part and hydrophobic part contact angles for the electroosmosis fabric in one embodiment of this invention.

FIGS. 10A to 10E show various embodiments of the electroosmosis fabric of this invention.

### DETAILED DESCRIPTION OF THE INVENTION

This invention unveils an innovation in active-perspiration activewear, engineered to enhance moisture control by emulating the physiological mechanisms of human sweat glands. Utilizing an innovative, textile-based, low-voltage electro-wicking process, the specialized garment adeptly transports excessive perspiration from the wearer's skin surface, expelling it in a dispersed droplet form. The expulsion system is intelligently calibrated to match the uppermost sweat rates witnessed in adults, whilst providing customizable adjustments to cater to the variable sweating levels among users.

Central to the design is a pioneering root-like distribution network constructed from a blend of hydrophilic and hydrophobic fibers. This intricate framework is adept at reducing the uncomfortable wet sensation and skin adherence typically associated with exercise and exertion. It adeptly manages liquid by guiding it from an initial broad gathering area down through narrowed conduits to strategic evaporation points, simulating the way natural flora draws moisture away from soil. These convergence points are home to the advanced electro-wicking ‘sweat glands’ which propel the rapid drying process.

Melding state-of-the-art knit textiles with revolutionary wearable technology, the activewear champions superior wearer comfort. By maintaining dryness, it also serves as a critical deterrent against heat-induced stress, thereby preserving the wearer's well-being. Tailored for the dynamic lifestyles of sports professionals, medical practitioners, construction workers, and emergency service providers, this garment stands as a vestment that transcends traditional sportswear, making it a groundbreaking contribution to the athletic and labor-focused apparel market. With its advanced moisture management capabilities, it positions itself as indispensable attire for individuals subjected to vigorous, sweat-inducing conditions.

In the pursuit of revolutionizing sportswear, an advanced active-perspiration garment designed to optimize moisture control is developed in this invention. This innovative attire emulates the body's own sweat glands, targeting the core principle of natural thermoregulation. The garment plans to effectively channel away excessive perspiration through a pioneering, low-voltage electro-wicking technology that is seamlessly integrated into the fabric. This system is engineered to manage liquid dissipation at rates that can parallel, or even exceed, the profuse sweating experienced by an adult during intense physical exertion. The technology is sensitive enough to be fine-tuned to match individual moisture levels, ensuring personalized comfort.

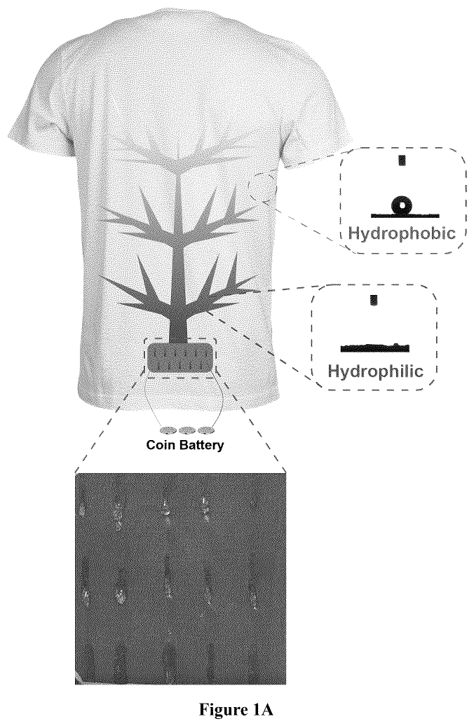

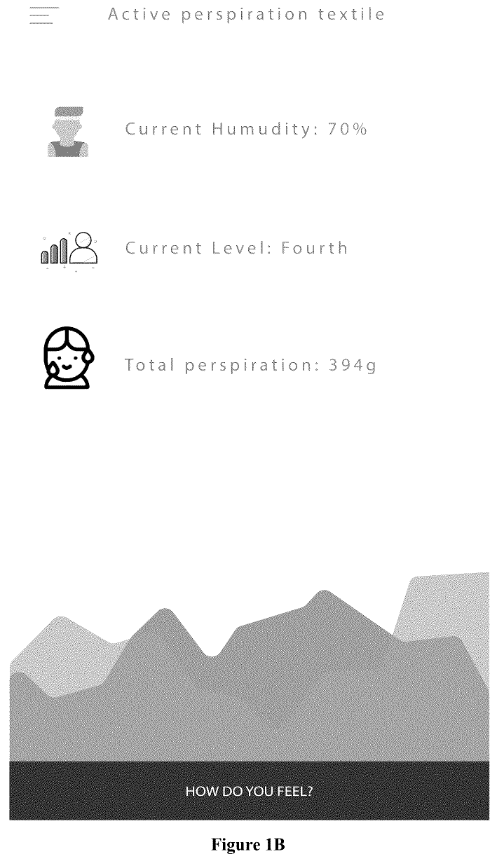

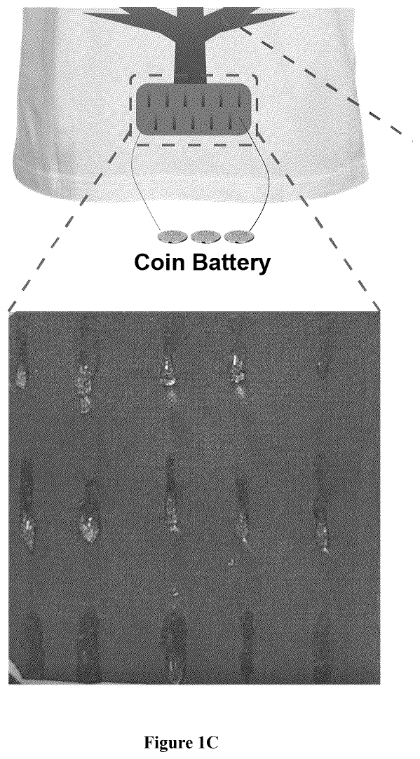

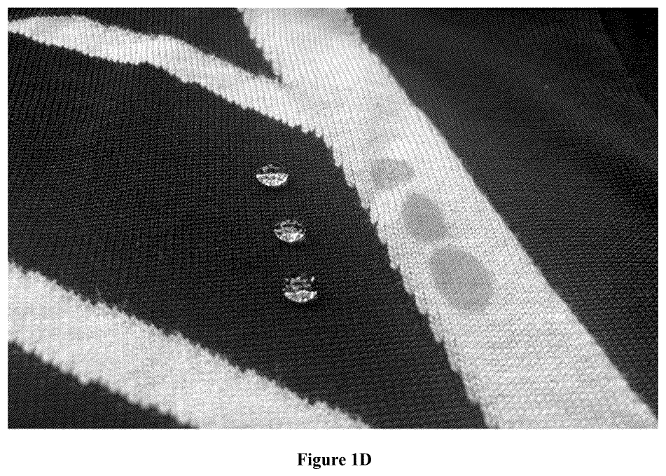

Building upon this, a sophisticated root-like liquid transport framework within the fabric is created. This system will tap into the dual properties of hydrophilic and hydrophobic yarns to engineer a sensation that opposes wetness and reduces the tendency of the fabric to cling to the skin. Advanced textile engineering will direct the transport of moisture within a deliberate area-line-point pattern, ensuring that sweat is not just absorbed, but actively moved to specialized zones where electro-wicking ‘sweat glands’ facilitate quick sweat dissipation as shown in FIGS. 1A to 1D. This next-generation sportswear marries traditional knitting crafts with state-of-the-art wearable technology. The result is a garment that offers unprecedented dryness and comfort to the wearer, significantly diminishing the occurrence of heat-induced discomfort. Such capabilities make the sportswear an indispensable ally for sports professionals, healthcare workers, laborers in construction, and firefighters, whose rigorous activities demand a clothing solution that can keep up with their high-output lifestyles. This garment's potential impact on occupational safety, performance, and overall wellbeing is profound, marking a stride towards the future of functional apparel.

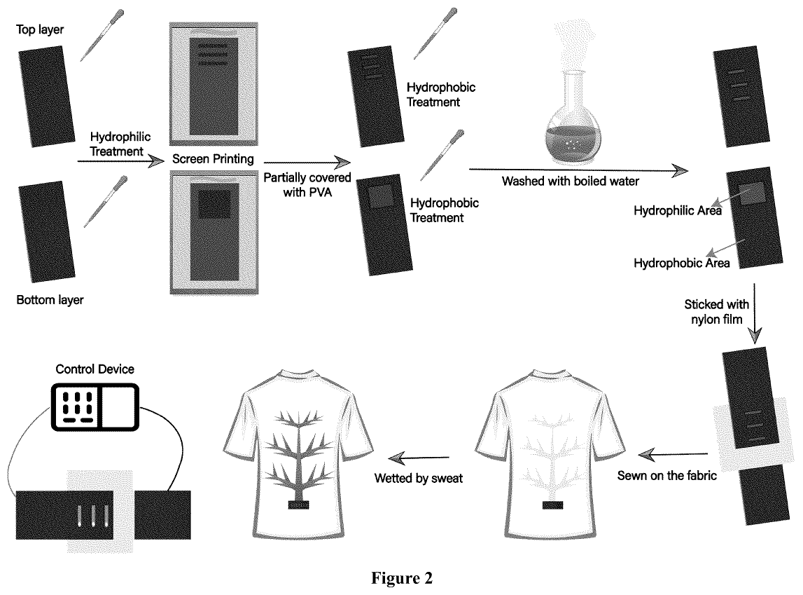

In one embodiment, this invention develops a fabric-based electro-wicking device featuring: Construction with a microporous membrane sandwiched between conductive fabric using porous fusible interlinings; Coating of membrane boundaries with impermeable soft silicone to prevent electrode contact; Firm attachment to knitted activewear using hydrophobic threads, specifically at the root structure's bottom area for efficient sweat collection and dissipation as shown in FIG. 2.

In one embodiment, this invention involves the surface treatment of the electro-wicking device to include: Pre dominant hydrophobicity with localized hydrophilic dotted-line patterns for enhanced droplet-form dissipation from ‘sweat glands’; Exploitation of differential wettability to extrude liquid with lower penetration pressure in hydrophilic areas compared to hydrophobic areas.

In one embodiment, this invention involves the application of scalable screen printing techniques for: Creation of large fabrics with the wettability pattern, allowing cutting into smaller samples for the electro-wicking device; Preparation of a hydrophilic coating by dip-coating fabric with hydrophobic solution, followed by heat curing; Mask creation with hollow dot patterns for screen printing, application of PVA mask solution, and subsequent heating to fix hydrophobic coating.

In one embodiment, this invention involves the integration of a compact power and control unit within the device: Inclusion of a tiny bleeder to modulate applied voltage according to perspiration levels or user preference; Coin batteries housed in a 3D printed TPU case within a hollow belt on the activewear; Conductive yarns sewn inside the belt, with a clip to secure the case to the user's pants belt.

This invention provides a fabric-based electro-wicking Device. In one embodiment, said device is constructed by layering a microporous nylon membrane with carbon woven fabric using porous fusible interlinings, ensuring efficient sweat transfer. In another embodiment, said device is coated with impermeable soft silicone at membrane boundaries to prevent contact between electrode layers. In a further embodiment, said device is attached to activewear with hydrophobic threads for firm placement and optimal sweat collection.

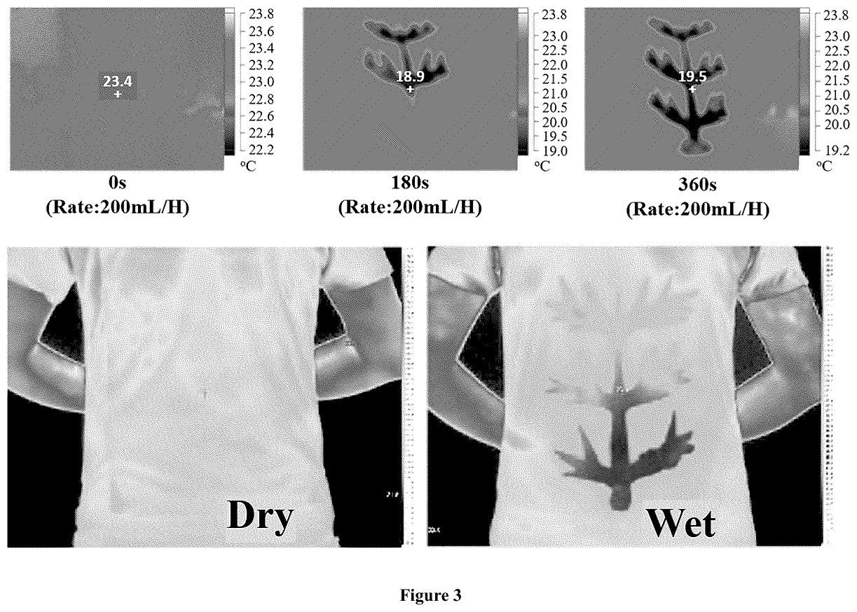

This invention provides a surface treatment for the electroosmotic fabric. In one embodiment, the outer surface is predominantly treated for hydrophobicity except for local dotted-line-like hydrophilic areas, facilitating targeted sweat dissipation. In another embodiment, the surface treatment of this invention creates a wettability gradient that guides the sweat to ‘sweat glands’ for expulsion as droplets, enhancing the drying process as shown in FIG. 3.

This invention also provides a scalable fabrication method for the electroosmotic fabric. In one embodiment, said method utilizes screen printing for large-scale application of the wettability pattern on fabrics. In another embodiment, said method involves washing carbon fabric, dip-coating in a hydrophilic solution, and curing. Optionally, similar treatment can be applied to polyester fabrics.

This invention also provides a scalable fabrication method for the electroosmotic fabric. In one embodiment, said method utilizes cutting techniques to directly cut out hydrophilic patterns in the sweat gland areas on the carbon fabric. The specific steps include: washing the carbon fabric, then using laser cutting or other cutting methods (includes die cutting, ultrasonic cutting, water jet cutting CNC cutting, hand cutting and plasma cutting) to cut the carbon fabric according to a preset pattern, thereby forming a patterned distribution of hydrophilic and hydrophobic regions on the surface of the carbon fabric. Similar treatment can also be applied to other fabric materials such as polyester.

This invention provides an electrode layer implementation for the electroosmotic fabric. Hydrophilic fabric may be used directly as an inner electrode layer. PVA-based mask solutions are applied for patterning during screen printing.

This invention provides power and control unit integration for the electroosmotic fabric. In one embodiment, the fabric incorporates a lightweight unit for voltage control, enabling three levels of sweat dissipation adjustment. In another embodiment, Strategically embeds and sews conductive yarns within a belt, housing a 3D-printed TPU case for batteries.

The innovative features described above enhance the state-of-the-art technology in moisture management for activewear. These improvements include a fabric-based, low-voltage electro-wicking device, which emphasizes swift and localized sweat removal. This targeted approach outperforms current materials that generally offer passive wicking and can become saturated with moisture. By facilitating moisture transport in a controlled manner, the activewear ensures the wearer's skin remains dry, enhancing comfort and performance.

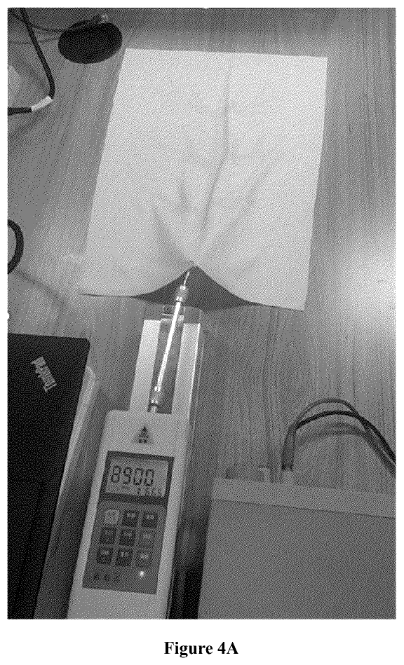

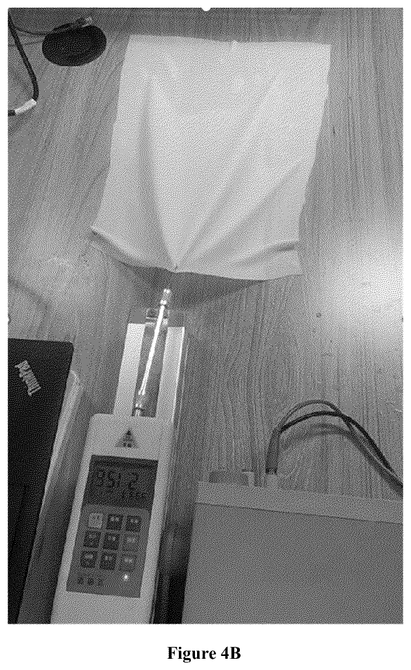

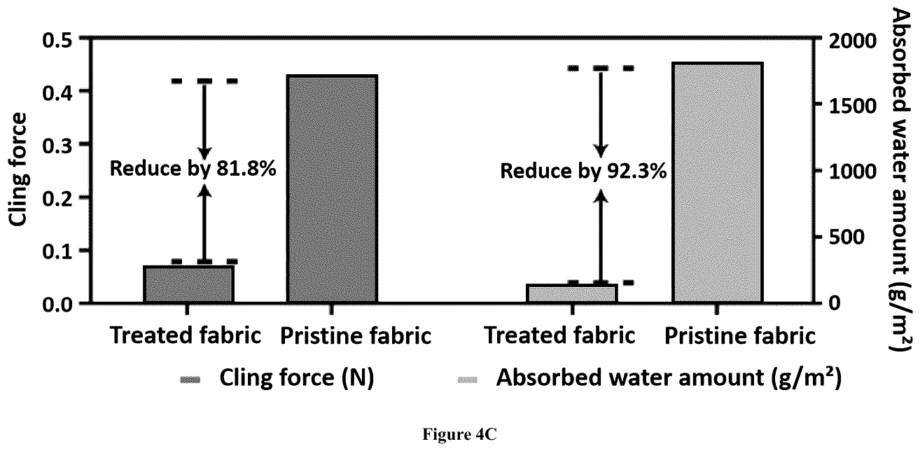

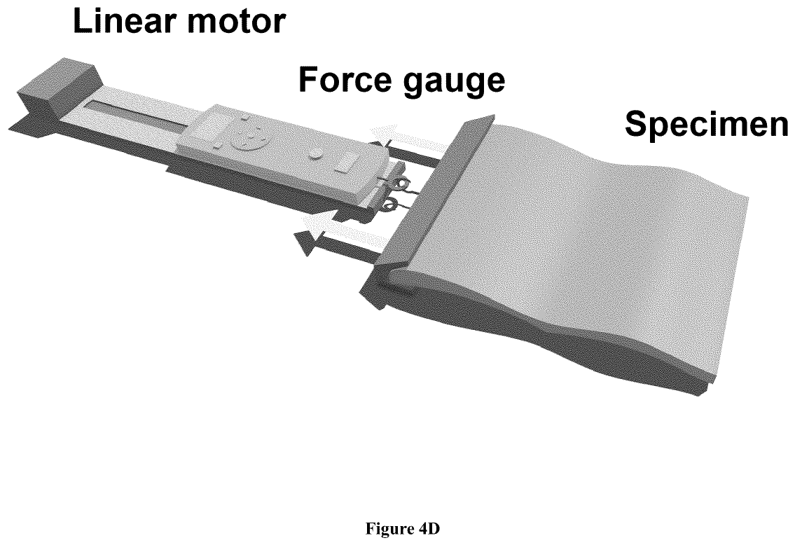

The integration of a root-like liquid transport system within the activewear's structure provides an additional layer of moisture management, using an intuitive blend of hydrophilic and hydrophobic yarns. This configuration mimics natural systems, which contributes to a more comfortable and less clingy garment compared to those made from standard, non-differential materials. Moreover, the manufacturing process described proposes enhancements over current industry practices. The scalable screen printing method for producing the electrowicking garment simplifies the fabrication process and is likely to reduce costs, making it an economically viable solution suitable for mass production. The experiment showed that the cling force was reduced more than 80% as shown in FIGS. 4A to 4D.

The inclusion of a tiny and lightweight power and control unit within the device embodies a move towards a more responsive and user-tailored system. With the capacity to modify the sweat dissipation rate, the activewear can be adapted to suit a variety of personal preferences and activity levels, a level of customization not typically afforded by conventional fabrics. Collectively, the innovative aspects lead to activewear that is not only more effective at managing perspiration but is also more pleasant to wear, ensuring that comfort is maintained even under strenuous conditions. Consequently, there are practical implications for a broad range of applications, including use by sports professionals, in labor-intensive workplaces, or medical settings. The invention resolves a suite of technical issues associated with existing activewear and stands as a testament to the ongoing evolution in the field of smart textiles and comfortable, performance-oriented apparel.

This invention provides a fabric for moisture control of a surface. In one embodiment, said fabric comprises a moisture collection component (1) or a moisture dissipation component (2); wherein said moisture collection component (1), comprises an outer surface (11) exposed to ambient environment and an inner surface (12) for contacting said surface, wherein moisture is removed from said surface due to passive forces acting in a capillary network (13) present in said moisture collection component (1); said moisture dissipation component (2), comprises a first electrode layer (24), a second electrode layer (25), one or more porous insulation layer (201) and an electrical supply (23), wherein said one or more porous insulation layer (201) is positioned between said first electrode layer and said second electrode layer while said electrical supply (23) maintains a voltage difference to drive an electroosmotic liquid flow.

In one embodiment, said fabric comprises said moisture collection component (1) and said moisture dissipation component (2); wherein said moisture collection component (1) is attached to said moisture dissipation component (2) so that said electrical supply (23) maintains said voltage difference across said capillary network (13) to drive said electroosmotic liquid flow to converge moisture from said capillary network (13) for removal through a dissipation region (3).

In one embodiment, said moisture collection component comprises a first region (101) and a second region (102).

In one embodiment, said first region (101) is hydrophobic and said second region (102) is: i) hydrophilic; ii) hydrophilic on said inner surface and hydrophobic on said outer surface; iii) hydrophobic on said inner surface and hydrophilic on said inner surface; iv) possesses a wettability gradient with said outer surface being more hydrophilic than said inner surface; or v) possesses a wettability gradient with said inner surface being more hydrophilic than said outer surface.

In one embodiment, said first region (101) is hydrophobic on said inner surface and hydrophobic on said outer surface while said second region (102) is: i) hydrophilic; ii) hydrophilic on said inner surface and hydrophobic on said outer surface; iii) possesses a wettability gradient with said outer surface being more hydrophilic than said inner surface; or iv) possesses a wettability gradient with said inner surface being more hydrophilic than said outer surface.

In one embodiment, said first region (101) is hydrophilic on said inner surface and hydrophobic on said outer surface while said second region (102) is: i) hydrophilic; ii) hydrophobic on said inner surface and hydrophilic on said outer surface; iii) possesses a wettability gradient with said outer surface being more hydrophilic than said inner surface; or iv) possesses a wettability gradient with said inner surface being more hydrophilic than said outer surface.

In one embodiment, said first region (101) possesses a wettability gradient with said outer surface being more hydrophilic than said inner surface while said second region (102) is: i) hydrophobic; ii) hydrophilic on said inner surface and hydrophobic on said outer surface; or iii) possesses a wettability gradient with said inner surface being more hydrophilic than said outer surface.

In one embodiment, said first region (101) possesses a wettability gradient with said inner surface being more hydrophilic than said outer surface while said second region (102) being: i) Hydrophobic; ii) hydrophilic on said outer surface and hydrophobic on said inner surface; or iii) possesses a wettability gradient with said outer surface being more hydrophilic than said inner surface.

In one embodiment, said second region (102) has a shape or a combination of shapes selected from the group consisting of squares, triangles, circles, ellipses, zigzag lines, spirals, grids, root-like, tree-like, leaf-like and interlocking shapes.

In one embodiment, said dissipation region (3) comprises at least one hydrophilic region (31) in a hydrophobic region (32).

In one embodiment, said dissipation region (3) is located on: a) said first electrode layer (24) or said second electrode layer (25); or b) a first layer (21) or a second layer (22).

In one embodiment, wettability of said first region (101) or said second region (102) is controlled by: a) coating at least one part of a preprocessed fabric with a hydrophobic material or a hydrophilic material; wherein said hydrophobic material is one or more selected from the group consisting of paraffin waterproofing agent, organic silicone resin waterproofing agent, fluorocarbon triple agent, long carbon chain waterproof and oil resistant finishing agent; and said hydrophilic material is one or more selected from the group consisting of acrylic hydrophilic finishing agent, polyamine hydrophilic finishing agent, epoxy hydrophilic finishing agent, polysiloxane and polyurethane hydrophilic finishing agent; b) by subjecting at least one part of a preprocessed fabric to one or more methods selected from the group consisting of screen printing, spraying, plasma exposure, UV treatment, and dipping; or c) knitting or weaving of hydrophilic yarns and hydrophobic yarns to produce a desired wettability.

In one embodiment, said voltage difference is >1V.

In one embodiment, said electroosmotic liquid flow a liquid transport rate between 0.0001-10 kg/m²/h. In another embodiment, said electroosmotic liquid flow has a liquid transport rate exceeding average human sweat rates.

In one embodiment, said moisture collection component (1) comprises a conductive fabric for use as said capillary network. In another embodiment, said conductive fabric is one or more selected from the group consisting of carbon cloth, carbon film, copper plated cloth, silver plated cloth, gold plated cloth, nickel plated cloth, aluminum plated cloth, conductive polymers, and graphene cloth.

In one embodiment, said moisture collection component (1) and said moisture dissipation component (2) are attached according to one or more of the following configurations: a) said first electrode layer comprises said dissipation region (3) and a first insulation layer (201), said second electrode layer comprises a second electrode layer (201), wherein said first electrode layer and said second electrode layer sandwich said moisture collection component (1); b) said first electrode layer comprises said dissipation region (3); said second electrode layer comprises a second electrode layer (201), wherein said first electrode layer and said second electrode layer sandwich an insulation layer (201); said second electrode layer attaches to said moisture collection component (1); c) said moisture dissipation component (2) further comprises a first layer having said dissipation region (3) and a second layer, wherein said first layer is attached to said first electrode layer and said second layer is attached to said second electrode layer; said first electrode layer and said second electrode layer sandwich an insulation layer (201), said second layer attached to said moisture collection component (1); d) said moisture collection component (1) further comprises said dissipation region (3) and a moisture transport region (14); wherein said dissipation region (3) and said moisture transport region (14) sandwich said moisture dissipation component (2); said moisture dissipation component (2) further comprises a first layer (21) and a second layer (22), wherein said first layer (21) is attached to said first electrode layer (24) and said second layer (22) is attached to said second electrode layer (25); said first electrode layer (24) and said second electrode layer (25) sandwich a porous insulation layer (201); said first layer (21) is attached to said dissipation region (3) and said second layer (22) attached to said moisture transport region (14).

In one embodiment, said moisture dissipation component (2) comprises a directional liquid transport function achieved by cutting methods and/or by a template sacrifice method. In another embodiment, said cutting methods is one or more selected from the group consisting of: laser cutting, die cutting, ultrasonic cutting, water jet cutting CNC cutting, hand cutting and plasma cutting. In a further embodiment, said template sacrifice method comprises coating the fabric in hydrophilic or hydrophobic solutions using a mask solution.

The invention also provides a garment made using the fabric of this invention. In one embodiment, the garment is selected from clothing, insoles, tent, curtain, hat, umbrella and cushion.

This invention also provides a system for moisture control of a surface. In one embodiment, said system comprises: a) the fabric of this invention; b) a mobile device; and c) a wireless module to achieve a desired liquid transport rate for said fabric by: i) Receiving instructions from said mobile device; and ii) Controlling said electrical supply based on said instructions to adjust said voltage difference to arrive at said desired liquid transport rate.

In one embodiment, the passive forces acting in the capillary network (13) comprises capillary flow, gravity or their combination.

In one embodiment, said porous insulation layer (201) is made from one or more materials selected from the group consisting of PTFE, nylon, polyester, cotton, silk, wool, viscose, linen, sisal, hemp, PP, PE, PAN, PES, PS, and PLA, PVA, PI, PU, PVC, silica gel, glass fiber, ceramic membrane, cellulose films.

In one embodiment, said porous insulation layer (201) has a pore size of 0.01 micron to 0.5 mm and/or a porosity of 0.01-0.99.

In one embodiment, said positive electrode layer (24) or said negative electrode layer (25) comprises one or more materials selected from the group consisting of carbon fiber cloth and fabrics or mats coated with or made by conductive materials.

In one embodiment, said at least one hydrophilic region (211) is made by treating a first electrode layer (24) locally. The treated first electrode layer (24) contains hydrophilic regions or dots for water dissipation like “sweat glands”; the surrounding regions can be hydrophobic.

In one embodiment, the moisture collection component (1) can be attached on the outer or inner surface of the moisture dissipation component (2) by sewing, fusing, stitching, hot pressing, adhesive bonding, ultrasonic welding, mechanical fastening, knitting locking, lamination, applique, etc.

In one embodiment, a first layer (21) and a second layer (22) can be added for protection and/or moisture wicking. In one embodiment, the first layer (21) can be part of moisture dissipation component (2). In this case, the first layer (21) contains hydrophilic regions like “sweat glands”; The surrounding regions can be hydrophobic. In another embodiment, the second layer (22) can be part of moisture dissipation component (2). The attachment can be made by sewing, fusing, stitching, hot pressing, adhesive bonding, ultrasonic welding, mechanical fastening, knitting locking, lamination, applique, etc.

In one embodiment, moisture dissipation component (2) can also contact a porous insulation layer directly for moisture transfer.

In one embodiment, first electrode layer (24) and second electrode layer (25) can be various conductive materials, such as carbon fabrics, metal coated fabrics, conductive ink layers, porous metal film, porous carbon fiber film, conductive nanofiber membranes, conductive foams, porous graphene, carbon nanotube films, conductive ceramic films, metal nanowire networks, metal-coated films, etc.

In one embodiment, the porous insulation layer can be various porous layers made by Nylon, PTFE, PVDF, PE, PP, PES, PAN, PS, PVA, PI, PU, PVC, silica gel, glass fiber, ceramic membrane, cellulose films, etc. The pore size can be 10 nm-0.5 mm. The porosity can be 0.01-0.99.

In one embodiment, said first region (101) or said second region (102) can also be developed by knitting (including ribbing, intarsia, tuck stitch, fair isle, brioche, cables, lace, garter stitch, stockinette stitch, seed stitch, double knitting, mosaic knitting, slip stitch, twisted stitch, entrelac) or weaving (including plain weave, twill weave, satin weave, basket weave, jacquard weave, herringbone weave, dobby weave, leno weave, rep weave, filament weave) of hydrophilic yarns and hydrophobic yarns to produce a desired wettability.

In one embodiment, said second region has a shape selected from the group consisting of squares, triangles, circles, ellipses, zigzag lines, spirals, grids, root-like, tree-like, leaf-like and interlocking shapes, rectangles, hexagons, pentagons, octagons, parallelograms, trapezoids, stars, heats, diamonds, crosses, arrows, polygons, fractals, etc. They can be connected or discrete. The area of each pattern can be 1 mm² to 1 m². In another embodiment, the shapes of the dissipation region can also have the above shapes. The area of each region or dot can be 0.01 mm² to 1 cm².

In one embodiment, where the fabric of this invention is used on a garment, the moisture dissipation component (2) is relocated to the interior side of the garment. The capillary flow will pass through a fabric fixed on the garment, and the first layer will be hydrophilic. Additionally, a hydrophobic region will be applied to the garment, while at least one hydrophilic area will be applied to the garment to facilitate liquid transport.

In one embodiment, said wireless module of the system of this invention communicates with said mobile device via one or more wireless technologies selected from Bluetooth, NFC, RFID, network, and WiFi.

The invention will be better understood by reference to the Experimental Details which follow, but those skilled in the art will readily appreciate that the specific experiments described are only for illustrative purpose and are not meant to limit the invention as described herein, which is defined by the claims that follow thereafter.

Throughout this application, various references or publications are cited. Disclosures of these references or publications in their entireties are hereby incorporated by reference into this application in order to more fully describe the state of the art to which this invention pertains. It is to be noted that the transitional term “comprising”, which is synonymous with “including”, “containing” or “characterized by”, is inclusive or open-ended and does not exclude additional, un-recited elements or method steps.

### Example 1

### Garment Fabrication by Chemicals

The fabrics were washed with distilled water and dried in the oven before use. Masks with designed patterns were fabricated by 3D printing or customized screen printing mask. 15 g Polyvinyl alcohol (PVA) was added into 100 ml water, magnetic stirred at 90° C. for 8 hours to prepare the mask solution. The fabric was fixed on a mask, with PVA mask solution poured onto the mask. The mask solution was trowelled by a scraper. Remove the mask and dry the fabric in the oven at 135° C. for 10 mins.

The hydrophobic coating solution was prepared by adding 4 g Nuva N1811 in 100 ml water, magnetic stir for 1 hour. After that, the masked fabric was dip coated in the hydrophobic coating solution and cured in the oven at 145° C. for 30 mins. Then, the coated sample was immersed in boiling water until all PVA mask was dissolved and washed away. Finally, dry the sample in oven at 135° C. for 30 mins again, the patterned fabric with DWT was achieved.

### Example 2

### Garment Fabrication by Knitting

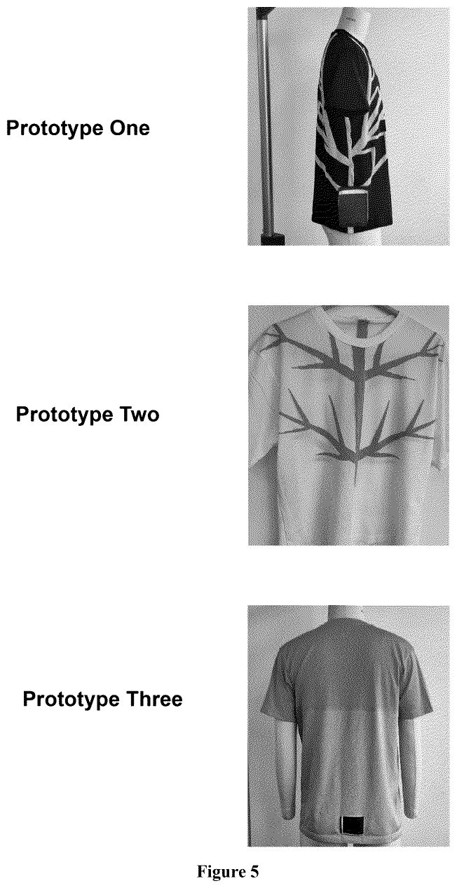

The process starts by selecting the appropriate yarns: hydrophobic yarns that repel water and hydrophilic yarns that attract and absorb moisture. These yarns are then loaded onto a knitting machine equipped with programmable patterns. The knitting pattern is designed to place the hydrophilic yarns in specific zones where moisture absorption is desired and hydrophobic yarns where moisture repulsion is needed. As the knitting commences, the machine weaves the yarns together in a predetermined design that accommodates the desired moisture management features. This might involve creating channels with hydrophilic yarns surrounded by hydrophobic yarns that serve to drain sweat away from the body to zones where it can evaporate quickly. The precision of the knitting machinery ensures that the hydrophilic and hydrophobic yarns are positioned accurately to achieve the targeted wicking and drying effects. Upon completion, the knitted fabric comprises patterns that vary in wettability, having regions that quickly move moisture away from the skin thanks to the hydrophilic yarns, and areas that prevent liquid from penetrating due to the presence of hydrophobic yarns. FIG. 5 shows the end product is a fabric that intelligently manages moisture based on the different properties of the yarns and the strategic design of the knitting pattern, providing comfort and dryness where it's most needed.

### Example 3

### Conductive Fabric Modification

The carbon cloth inherently possesses a degree of hydrophobicity, indicating that its water absorption capacity is not optimal. Hence, a hydrophilic agent is applied to the fabric's inner surface to enhance its ability to absorb sweat produced or collected on the skin. On the outer surface, a hydrophobic treatment is applied to obstruct water vapor or ambient moisture from being absorbed and released on the inner surface. The hydrophilic line functions as a conduit for the release of absorbed water.

At first, a hydrophilic coating solution will be created by introducing 2 g Hansi WS into 100 ml distilled water. The fabric will then be immersed in the solution and heat-cured in an oven at 180° C. for 2 minutes. Notably, this hydrophilic fabric can be directly employed as the internal layer of the electrode. Thereafter, masks possessing a hollow, dot-like pattern will be constructed for screen printing. Polyvinyl alcohol (PVA) will be combined with water to achieve a solution concentration of 15%, which will be magnetically stirred at 90° C. for 8 hours to prepare the mask solution. The fabric will be affixed to a specially designed screen mask, with PVA solution poured onto the mask. The mask solution will be evenly distributed by a scraper. The subsequent step involves removing the mask and heating the fabric in an oven at 135° C. for 10 minutes. A hydrophobic coating solution will be prepared by introducing 4 g Novec N1811 into 100 ml of distilled water, then stirring magnetically for 1 hour. The masked fabrics will be submerged in the hydrophobic coating solution and oven-cured at 150° C. for 2 minutes. The coated samples will then be immersed in boiling water until all PVA has dissolved and been rinsed away. Ultimately, the samples will be oven-dried at 150° C. for 3 minutes.

Optionally, polyester fabrics can be treated for patterned wettability and affixed to the external carbon fabric. This procedure will render the external face with an appearance and tactile property identical to the surrounding areas.

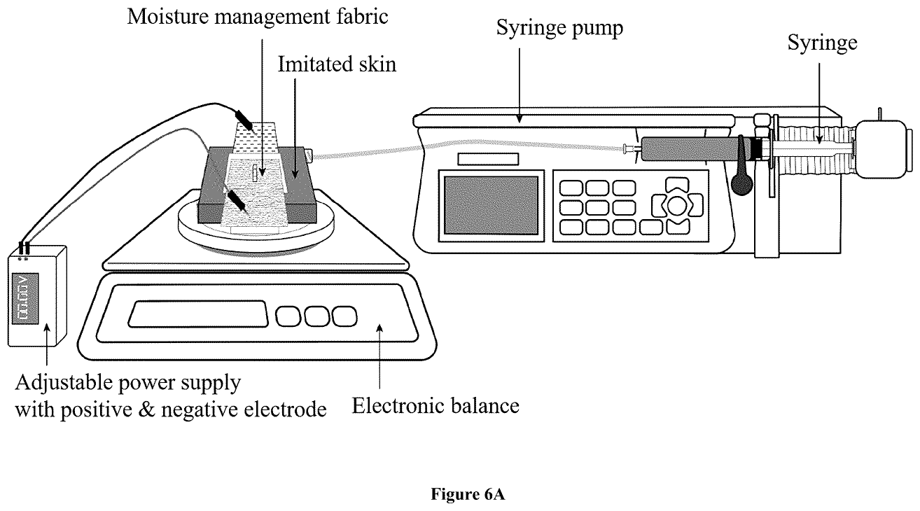

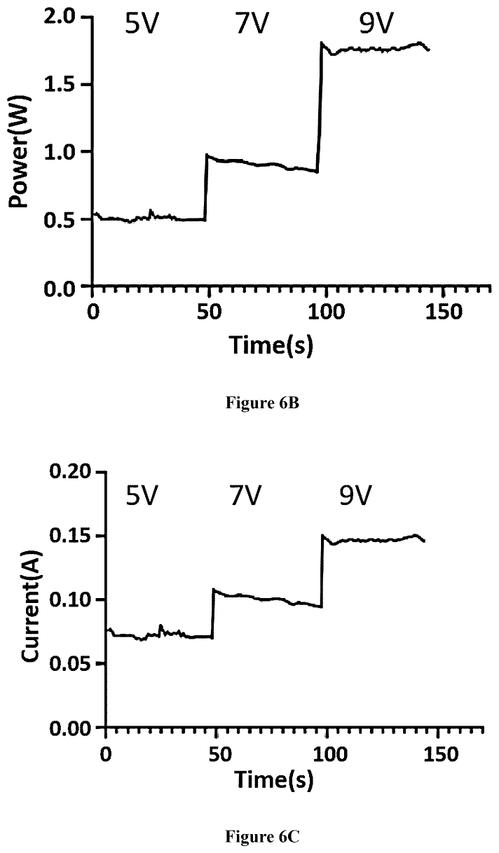

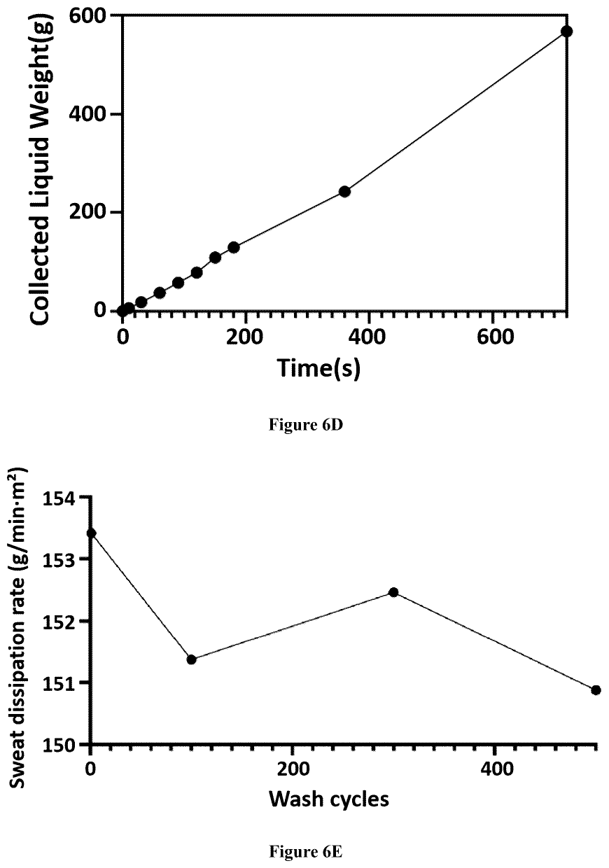

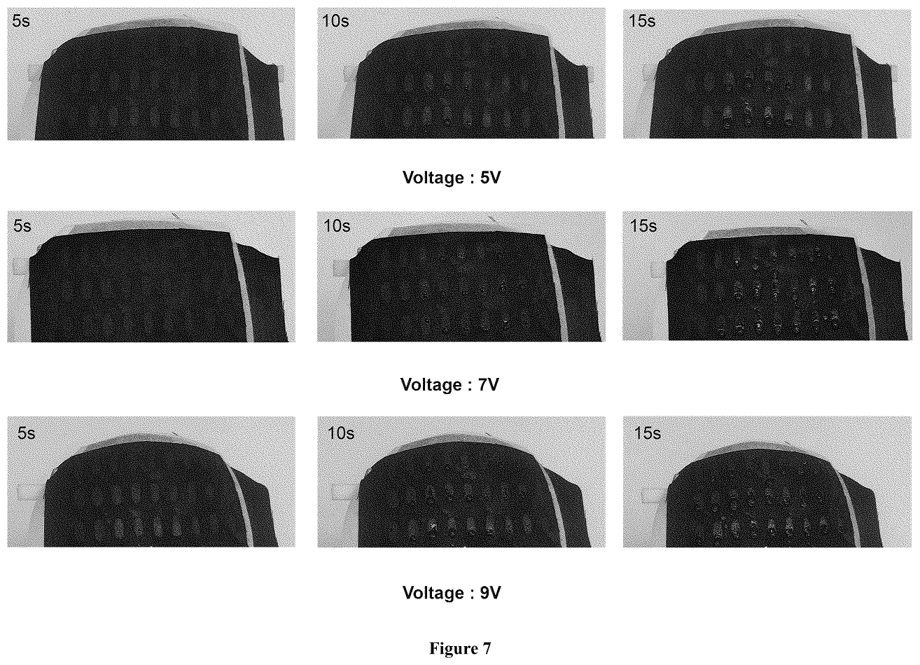

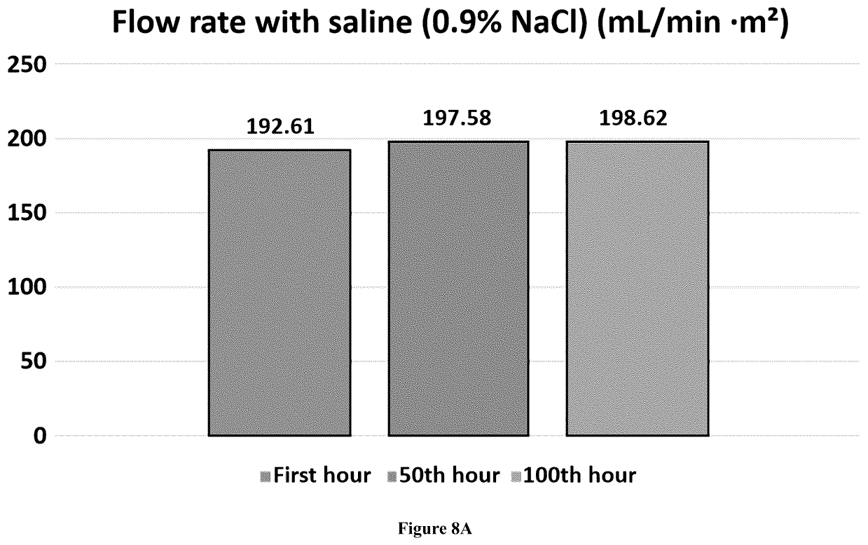

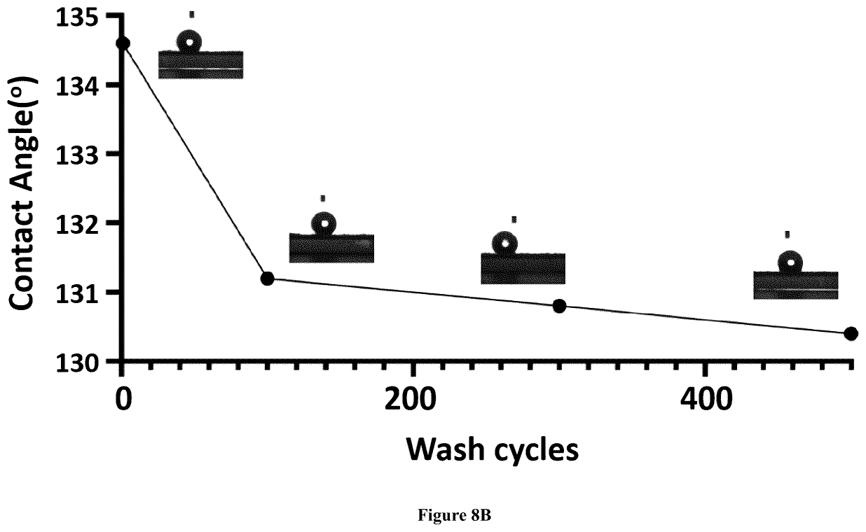

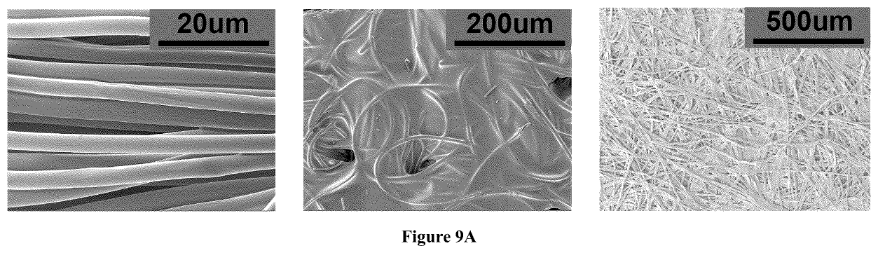

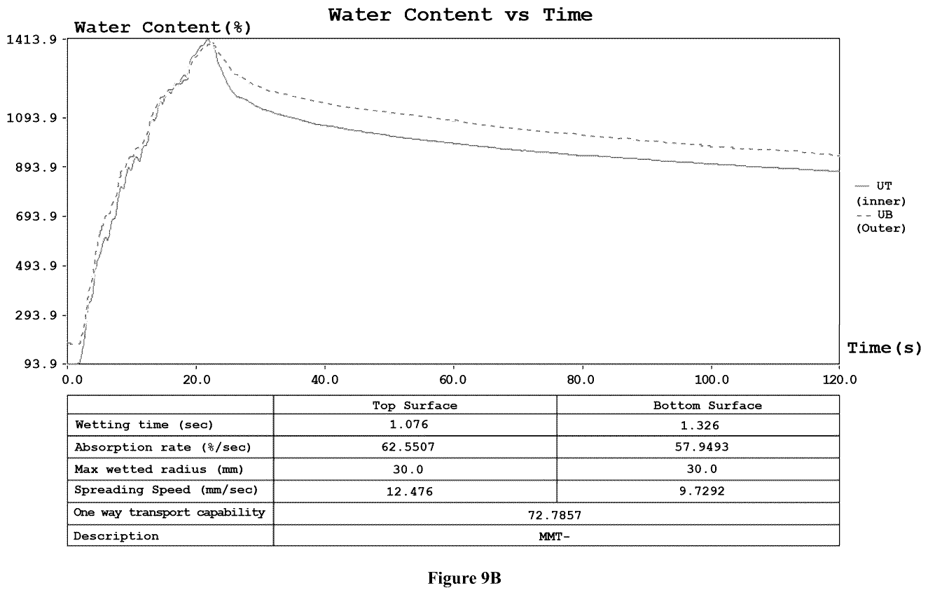

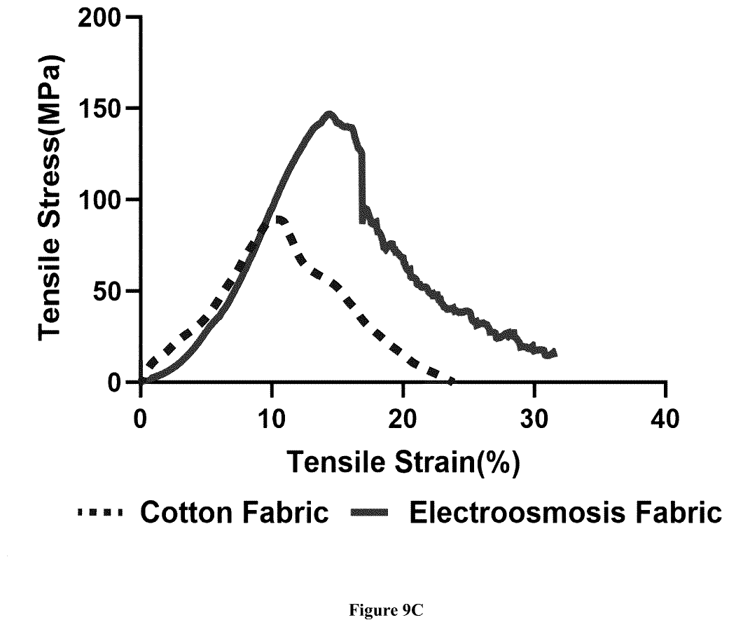

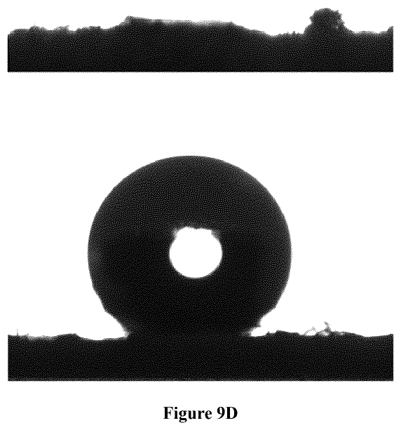

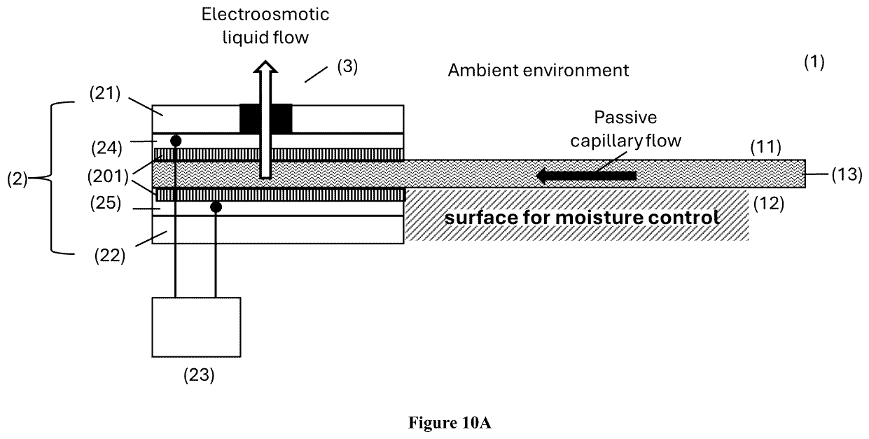

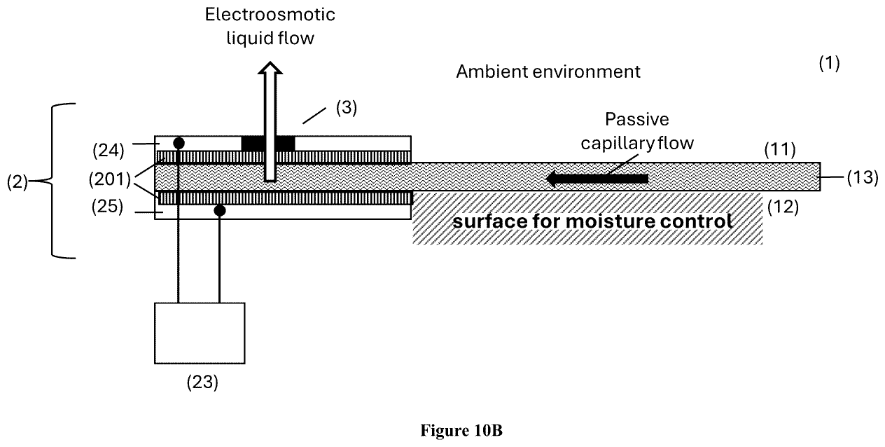

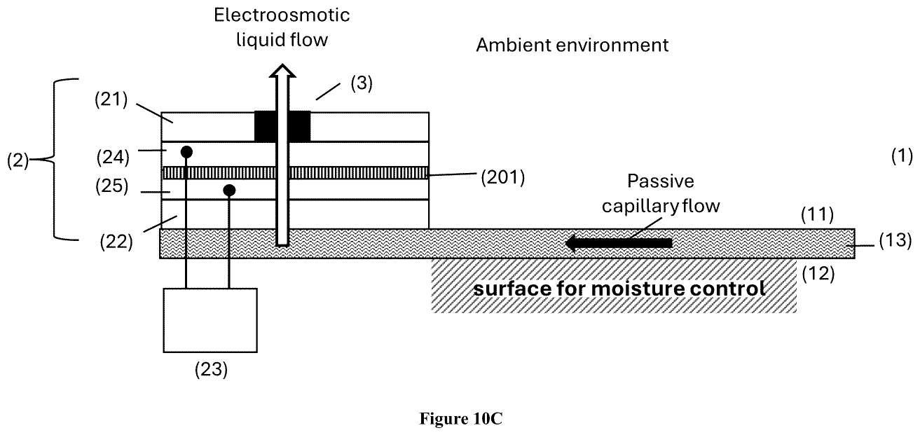

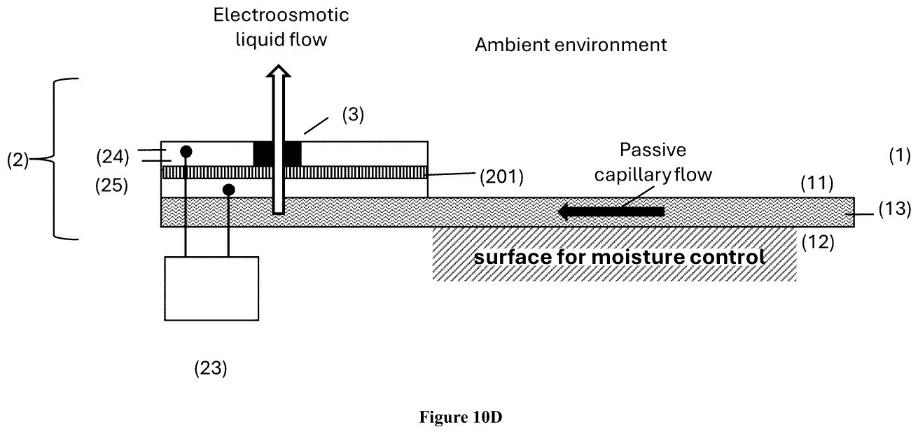

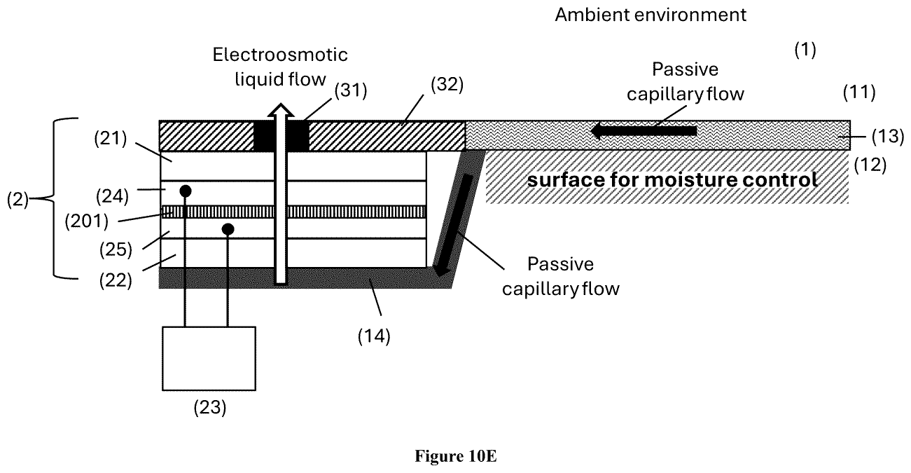

Post fabrication of the electroosmosis fabric, its capacity to transport water from the inner to the outer surface was evaluated. FIGS. 6A to 6E show the experiment set up, the untreated fabric was placed on the water surface and connected to the electrical supply. The outer surface of the fabric was then observed to determine whether water droplets had been transported and had surfaced. The appearance of water droplets on the outer surface would substantiate its water transport capabilities. Furthermore, the voltage (V) applied to the fabric commenced from minimum values (i.e., 1V). The voltage was increased incrementally by 1V every 2 minutes until the emergence of water droplets on the outer surface. Consequently, the appearance of fabric under different voltage was shown in FIG. 7 and the minimum voltage necessary to initiate water transport was documented. The results are shown in Table 1. The durability of device have also been well evaluated, the liquid transport rate did not reduce after 100 hours test with saline or after wash as shown in FIGS. 8A to 8B.

TABLE 1
The time required for each trial to
finish one water droplet lifecycle.

Time (s)

| | | | | |
|---|---|---|---|---|
| Voltage | 1^{st} test | 2^{nd} test | 3^{rd} test | 4^{th} test |

| | | | | | |
|---|---|---|---|---|---|
| 5 | V | 112 | 136 | 147 | 156 |
| 7 | V | 103 | 107 | 114 | 100 |
| 9 | V | 38 | 47 | 42 | 46 |
| 12 | V | 197 | / | / | 187 |

Despite the absorbed water directing and forming droplets on the hydrophilic line, there were a number of minute droplets formed on the hydrophobic region of the outer surface. The quantity of these unexpected droplets increased with time without being shed off the surface. This negatively impacts the efficiency of the fabric's water transportation and reduces user convenience, as the surface isn't dry and could moisten other objects.

Three potential explanations for this phenomenon are proposed. The first is the inadequate or uneven dispersion of hydrophobic particles. Given the hydrophobic treatment applied to the outer surface (excluding the hydrophilic line), water isn't expected to be released from the fabric due to lower wettability. If water can traverse the hydrophobic region of the outer surface, this implies that the fabric isn't sufficiently hydrophobic due to an inadequate or uneven distribution of hydrophobic particles. The second explanation relates to the carbon cloth structure. As it is a woven fabric composed of warp and weft yarn, there exists a degree of interspace between these yarns. With sufficiently high applied voltage, water droplets might overcome the resistance of the water repellency force and traverse to the outer surface through the gap between the warp and weft yarn. Hence, the unexpected formation of small droplets. The final explanation involves the hydrophilic line being overloaded by a considerable amount of transported water. Similar to the reasoning for fabric operation under 5V, excess water will seek a new, less resistive path for outflow. Since the water absorption area (i.e., inner surface) is larger than the water release area (i.e., hydrophilic line on the outer surface), if a substantial volume of water is absorbed, the hydrophilic line becomes overloaded. The surplus water, propelled by electroosmosis, traverses through the outer surface. Therefore, any gaps between the warp and weft yarn with a lax structure or diminished hydrophobic properties become additional pathways for water outflow, resulting in the formation of small droplets on the hydrophobic area.

A fabric with an innovative low-voltage-driven mechanism for moisture management, harnessing the principles of electroosmosis, is engineered. By establishing a connection where the outer surface, which interacts with the environment, is linked to the positive electrode and the inner surface, which lies close to the body's microclimate, to the negative electrode, the fabric actively draw in moisture from the hydrophilic inner side and transport it to the hydrophobic outer surface. At this outer layer, the moisture converges at specifically designed hydrophilic channels and is effectively propelled away from the fabric through the induced electroosmotic flow.

How various operational parameters affected the smart fabric's performance is further explored. It was established that an optimal voltage of 9 volts allowed the fabric to reach a stable water transportation performance without the formation of extraneous moisture around the designated hydrophilic channels. Additionally, it was observed that the fabric could proactively manage the movement of moisture by simply adjusting the power source. Investigation into the water resistance properties of the fabric's outer surface uncovered that higher voltages could bolster water resistance, likely due to the strengthening of electroosmotic forces counteracting external water pressure.

The practical application potential of the smart fabric was assessed through simulations replicating human perspiration, revealing a striking average water transport rate of 180.26 grams per minute—significantly exceeding average human sweat rates, indicating the fabric's capability to rapidly eliminate excess moisture. This positions the smart fabric of this invention as an ideal solution for daily wear, satisfying the practical demands of garment moisture management. This technology is actualized within everyday and specialized apparel by creating a unique fabric-based electroosmotic pump system, characterized by its asymmetrical electrode configuration, robust flexibility, and controlled water transportation potentials. Consisting of pliable carbon fiber and nonwoven electrodes, this system displays remarkable malleability, making it supremely suitable for integration into versatile smart textile applications. The electrodes' higher conductivity levels facilitate fluid movement at low operational voltages and current, enhancing efficiency. By integrating this system with a compact, wireless Bluetooth module, its utility in applications such as sports insoles and performance apparel is showcased. This successful demonstration not only confirms its immediate tangible use but also establishes a foundation for future adaptations across various domains and technologies.

In one embodiment, the middle membrane materials within the invention can be substituted with a range of alternative microporous substrates beyond the initial proposition of expanded polytetrafluoroethylene (ePTFE) and microporous polyurethane. These alternatives include various materials, each bringing its distinct attributes of porosity and material compatibility.

In one embodiment, cellulose-based membranes present a promising option, offering the advantage of being created from renewable resources and their inherent biodegradability. Cellulose membranes can be engineered to have specific pore sizes and distributions, making them suitable for precise moisture control applications. Additionally, membranes crafted from materials like polysulfone, polyamide, and polyacrylonitrile could be tested for their robust mechanical properties and chemical resistance, which might be essential for certain usage scenarios.

In one embodiment, nanofiber membranes fabricated from electrospinning processes offer unique advantages due to their high surface area-to-volume ratio, allowing for rapid moisture transport. Polylactic acid (PLA), a biopolymer derived from corn starch or sugar cane, is another alternative that could be considered for its eco-friendly profile and ease of processing into membranes with tailored properties.

In one embodiment, bio-based membranes such as chitosan, which is derived from the shells of crustaceans, could also be explored for their natural biocompatibility and moisture management properties. Furthermore, composite membranes that combine different materials, potentially marrying the benefits of mechanical stability and fine-tuned wettability, could provide an innovative approach to active moisture wicking.

In one embodiment, these material alternatives, each with its specific advantages and potential drawbacks, offer a spectrum of possibilities that can further optimize the invention's performance in moisture management while also aligning with broader sustainability goals. The selection of suitable membrane material would need to factor in the intended application environment, desired longevity, and impact on the overall functionality of the device.

In one embodiment, the carbon cloth in the device, selected for its conductive properties, can be replaced with a variety of other conductive textiles. Textiles woven with silver or copper fibers are highly conductive and maintain excellent electrical characteristics, making them suitable alternatives. Graphene-infused fabrics are also an effective option, offering not only high conductivity but also enhanced flexibility and strength that may surpass traditional materials. In addition to silver and copper, textiles incorporating other metal fibers, like gold and nickel, may be considered for their unique conductive profiles. Silver-coated fabrics, for instance, provide a balance between conductivity and textile flexibility, while copper-infused materials are known for their antimicrobial properties, which could be beneficial in active wearables. Gold-infused textiles, although more costly, could offer superior conductivity and resistance to oxidation.

In one embodiment, conductive polymers represent another class of materials that can substitute for carbon cloth. These polymers can be engineered to achieve desired electrical properties and can be integrated into fabrics to create smart textiles that respond to environmental stimuli. Moreover, hybrid textiles that blend metallic fibers with synthetic or natural fibers could confer added mechanical properties like stretchability and breathability while maintaining conductivity. Conductive paints and inks applied to fabric substrates extend the range of possibilities, enabling the creation of conductive pathways on traditional non-conductive fabrics. Each of these conductive materials could potentially be incorporated into the invention's design, enhancing its ability to manage moisture actively. The specific choice of conductive textile would depend on factors such as the required conductivity level, mechanical properties, compatibility with other components, and cost considerations. These materials collectively expand the versatility of conductive fabrics and their applications in wearable technology.

In one embodiment, the liquid transport pattern within a moisture management system can be varied in numerous ways, providing flexibility in design and functionality. These variations can include adjustments in the proportional area occupied by hydrophilic and hydrophobic regions within the fabric, as well as modifications in the geometric shapes and configurations of the patterns. Changing the proportion of hydrophilic to hydrophobic areas can directly influence how quickly and efficiently moisture is absorbed and transported across the fabric. A larger hydrophilic area might increase the absorption rate, while a greater hydrophobic portion could aid in faster moisture transport and evaporation.

In one embodiment, different shapes of unidirectional water-guiding patterns can also adjust the overall liquid transfer rate. For instance, within the range of 0.01 mm² to 500 cm², experimenting with pattern shapes such as squares, triangles, circles, ellipses, zigzag lines, spirals, grids, or interlocking shapes can all achieve this. Each pattern shape will create unique pathways for moisture to travel, and these pathways can be optimized based on the intended use of the activewear. Moreover, incorporating gradients within the hydrophilic and hydrophobic zones can result in more complex liquid transport dynamics, potentially leading to enhanced control over moisture movement and evaporation rates. These gradient patterns can either be smooth or have a stepwise transition, allowing for customized and area-specific management of moisture. Additionally, the proportion of a single pattern within the overall area can vary greatly, ranging from as little as 1% to as much as 100%. This variance further allows for the fine-tuning of liquid transmission properties to match specific performance requirements. The scalability of pattern sizing provides a versatile approach to engineering textiles that are tailored to specific needs, whether it's for managing perspiration in activewear or guiding moisture in technical fabrics. By adjusting the coverage of these unidirectional water-guiding patterns, manufacturers can manipulate the rate of liquid spread and evaporation, contributing to the fabric's overall functionality and comfort for the user.

In one embodiment, modifying the voltage parameters could involve integrating more sustainable power sources such as flexible photovoltaic cells or thermoelectric devices that harness body heat. This could lend the garment self-sustaining capabilities. An advanced voltage delivery system might also be implemented to provide finer control over the power supply, dynamically responding to varying perspiration levels or adapting to external environmental changes.

In one embodiment, the method of this invention is applicable across an array of both natural and synthetic fibers, which can be utilized in various knitting techniques or through chemical treatments. The natural fibers include cotton, wool, silk, linen, hemp, ramie, jute, cashmere, mohair, alpaca, angora, and semi-synthetic fibers like lyocell. The synthetic fibers suitable for this method are polyester, nylon, acrylic, polypropylene, spandex, acetate, rayon, modacrylic, aramid fibers such as Kevlar and Nomex, ultra-high-molecular-weight polyethylene like Dyneema or Spectra, and PTFE-based fibers like Teflon or Gore-Tex. Additionally, semi-synthetic fibers such as viscose, modal, lyocell (also known as Tencel), and bamboo viscose are also suitable. Moreover, blends such as polycotton, which combines polyester and cotton, and various wool blends that integrate wool with other fibers, can also be used. Each fiber type brings distinct characteristics to the table, which can affect the performance and outcome of the moisture management system, taking into account factors like hydrophobicity, tensile strength, elasticity, and thermal properties.

What is claimed is:

1. A fabric for moisture control of a surface, comprising a moisture collection component (1) or a moisture dissipation component (2); wherein
a. said moisture collection component (1), comprises an outer surface (11) exposed to ambient environment and an inner surface (12) for contacting said surface, wherein moisture is removed from said surface due to passive forces acting in a capillary network (13) present in said moisture collection component (1);
b. said moisture dissipation component (2), comprises a first electrode layer (24), a second electrode layer (25), one or more porous insulation layer (201) and an electrical supply (23), wherein said one or more porous insulation layer (201) is positioned between said first electrode layer and said second electrode layer while said electrical supply (23) maintains a voltage difference to drive an electroosmotic liquid flow.

2. The fabric of claim 1, wherein said fabric comprises said moisture collection component (1) and said moisture dissipation component (2); wherein said moisture collection component (1) is attached to said moisture dissipation component (2) so that said electrical supply (23) maintains said voltage difference across said capillary network (13) to drive said electroosmotic liquid flow to converge moisture from said capillary network (13) for removal through a dissipation region (3).

3. The fabric of claim 2, wherein said moisture collection component comprises a first region (101) and a second region (102).

4. The fabric of claim 3, wherein said first region (101) is hydrophobic and said second region (102) is:
i. hydrophilic;
ii. hydrophilic on said inner surface and hydrophobic on said outer surface;
iii. hydrophobic on said inner surface and hydrophilic on said inner surface;
iv. possesses a wettability gradient with said outer surface being more hydrophilic than said inner surface; or
V. possesses a wettability gradient with said inner surface being more hydrophilic than said outer surface.

5. The fabric of claim 3, wherein said first region (101) is hydrophobic on said inner surface and hydrophobic on said outer surface while said second region (102) is:
i. hydrophilic;
ii. hydrophilic on said inner surface and hydrophobic on said outer surface;
iii. possesses a wettability gradient with said outer surface being more hydrophilic than said inner surface; or
iv. possesses a wettability gradient with said inner surface being more hydrophilic than said outer surface.

6. The fabric of claim 3, wherein said first region (101) is hydrophilic on said inner surface and hydrophobic on said outer surface while said second region (102) is:
i. hydrophilic;
ii. hydrophobic on said inner surface and hydrophilic on said outer surface;
iii. possesses a wettability gradient with said outer surface being more hydrophilic than said inner surface; or
iv. possesses a wettability gradient with said inner surface being more hydrophilic than said outer surface.

7. The fabric of claim 3, wherein said first region (101) possesses a wettability gradient with said outer surface being more hydrophilic than said inner surface while said second region (102) is:
i. Hydrophobic;
ii. hydrophilic on said inner surface and hydrophobic on said outer surface; or
iii. possesses a wettability gradient with said inner surface being more hydrophilic than said outer surface.

8. The fabric of claim 3, wherein said first region (101) possesses a wettability gradient with said inner surface being more hydrophilic than said outer surface while said second region (102) being:
i. Hydrophobic;
ii. hydrophilic on said outer surface and hydrophobic on said inner surface; or
iii. possesses a wettability gradient with said outer surface being more hydrophilic than said inner surface.

9. The fabric of claim 3, wherein said second region (102) has a shape or a combination of shapes selected from the group consisting of squares, triangles, circles, ellipses, zigzag lines, spirals, grids, root-like, tree-like, leaf-like and interlocking shapes.

10. The fabric of claim 2, wherein said dissipation region (3) comprises at least one hydrophilic region (31) in a hydrophobic region (32).

11. The fabric of claim 2, wherein said dissipation region (3) is located on:
a. said first electrode layer (24) or said second electrode layer (25); or
b. a first layer (21) or a second layer (22).

12. The fabric of claim 3, wherein wettability of said first region (101) or said second region (102) is controlled by:
a. coating at least one part of a preprocessed fabric with a hydrophobic material or a hydrophilic material; wherein
said hydrophobic material is one or more selected from the group consisting of paraffin waterproofing agent, organic silicone resin waterproofing agent, fluorocarbon triple agent, long carbon chain waterproof and oil resistant finishing agent; and
said hydrophilic material is one or more selected from the group consisting of acrylic hydrophilic finishing agent, polyamine hydrophilic finishing agent, epoxy hydrophilic finishing agent, polysiloxane and polyurethane hydrophilic finishing agent;
b. by subjecting at least one part of a preprocessed fabric to one or more methods selected from the group consisting of screen printing, spraying, plasma exposure, UV treatment, and dipping; or
c. knitting or weaving of hydrophilic yarns and hydrophobic yarns to produce a desired wettability.

13. The fabric of claim 1, wherein said voltage difference is >1V.

14. The fabric of claim 1, wherein said electroosmotic liquid flow a liquid transport rate between 0.0001-10 kg/m²/h.

15. The fabric of claim 1, wherein said moisture collection component (1) comprises a conductive fabric for use as said capillary network.

16. The fabric of claim 15, wherein said conductive fabric is one or more selected from the group consisting of carbon cloth, carbon film, copper plated cloth, silver plated cloth, gold plated cloth, nickel plated cloth, aluminum plated cloth, conductive polymers, and graphene cloth.

17. The fabric of claim 2, wherein said moisture collection component (1) and said moisture dissipation component (2) are attached according to one or more of the following configurations:
a. Said first electrode layer comprises said dissipation region (3) and a first insulation layer (201), said second electrode layer comprises a second electrode layer (201), wherein said first electrode layer and said second electrode layer sandwich said moisture collection component (1);
b. Said first electrode layer comprises said dissipation region (3); said second electrode layer comprises a second electrode layer (201), wherein said first electrode layer and said second electrode layer sandwich an insulation layer (201); said second electrode layer attaches to said moisture collection component (1);
c. said moisture dissipation component (2) further comprises a first layer having said dissipation region (3) and a second layer, wherein said first layer is attached to said first electrode layer and said second layer is attached to said second electrode layer; said first electrode layer and said second electrode layer sandwich an insulation layer (201), said second layer attached to said moisture collection component (1);
d. said moisture collection component (1) further comprises said dissipation region (3) and a moisture transport region (14); wherein said dissipation region (3) and said moisture transport region (14) sandwich said moisture dissipation component (2); said moisture dissipation component (2) further comprises a first layer (21) and a second layer (22), wherein said first layer (21) is attached to said first electrode layer (24) and said second layer (22) is attached to said second electrode layer (25); said first electrode layer (24) and said second electrode layer (25) sandwich a porous insulation layer (201); said first layer (21) is attached to said dissipation region (3) and said second layer (22) attached to said moisture transport region (14).

18. The fabric of claim 1, wherein said moisture dissipation component (2) comprises a directional liquid transport function achieved by cutting methods and/or by a template sacrifice method.

19. A garment made using the fabric of claim 1.

20. A system for moisture control of a surface, comprising:
a. Said fabric of claim 1;
b. A mobile device; and
c. A wireless module to achieve a desired liquid transport rate for said fabric by:
i. Receiving instructions from said mobile device; and
ii. Controlling said electrical supply based on said instructions to adjust said voltage difference to arrive at said desired liquid transport rate.
